(19) United States
(12) Patent Application Publication
(10) Pub. No.: US 2026/0356370 A1
(43) Pub. Date: Nov. 12, 2026

(54) DRIVER ASSISTANCE CONTROL METHOD AND APPARATUS USING AN ECO-FRIENDLY VEHICLE

(71) Applicants: HYUNDAI MOTOR COMPANY, Seoul (KR); KIA CORPORATION, Seoul (KR)

(72) Inventor: Ye Rim Seo, Hwaseong-si (KR)

(73) Assignees: HYUNDAI MOTOR COMPANY, Seoul (KR); KIA CORPORATION, Seoul (KR)

(21) Appl. No.: 19/352,220

(22) Filed: Oct. 7, 2025

(30) Foreign Application Priority Data
May 12, 2025 (KR) 10-2025-0061402

(51) Int. Cl. B60W 30/182; B60W 20/14; B60W 30/18; B60W 30/188

(52) U.S. Cl. CPC B60W 30/182; B60W 20/14; B60W 30/18018; B60W 30/188; B60W 2510/244; B60W 2540/10; B60W 2540/12; B60W 2552/15

(57) ABSTRACT

A driver assistance control method and a driver assistance control apparatus using an eco-friendly vehicle are disclosed. The driver assistance control method includes determining an entry mode for driver assistance control based on location information of a vehicle or information received from a sensor based on a driver assistance control mode being activated. The driver assistance control method further includes determining a control stage for determining a procedure for controlling the vehicle based on the entry mode and vehicle situation information. The driver assistance control method further includes controlling the vehicle based on the control stage and battery status information.

### CROSS-REFERENCE TO THE RELATED APPLICATION

This application claims the priority to and benefit of Korean Patent Application No. 10-2025-0061402, filed on May 12, 2025 in the Korean Intellectual Property Office, the entire contents of which are incorporated herein by reference.

### TECHNICAL FIELD

The present disclosure relates to a smart vehicle, and more specifically, the present disclosure relates to a driver assistance control method and apparatus using an eco-friendly vehicle.

### BACKGROUND

Recent traffic environments increase the possibility of accidents due to driver negligence and require technological development to improve driving convenience through auxiliary control functions of vehicles.

For example, in the case of a vehicle not equipped with an electronic toll collection terminal, the driver needs to decelerate and stop the vehicle when entering a toll gate. In this process, the driver needs to perform various operations such as changing gears, opening and closing windows, and collecting and paying for passes. This situation not only causes inconvenience to the driver but also increases the possibility of accidents due to negligence such as missing or incorrectly performing important safety-related operations.

Conventional inertial driving control mainly focuses on improving vehicle driving efficiency and thus has limitations in improving driver convenience. In addition, conventional technologies do not assume a temporary stop situation and lack additional control functions to maintain an electric vehicle mode (EV mode) by maximizing regenerative braking before stopping. Furthermore, conventional control methods do not expand a control entry range through association with sensors such as a vehicle front camera or smartphone applications in addition to navigation signals.

Therefore, in this technology field, there is a demand for a technology for simultaneously improving driver safety and convenience by utilizing auxiliary control functions of an eco-friendly vehicle in a situation in which a temporary stop is expected while driving the eco-friendly vehicle.

The statements in this section merely provide background information related to the present disclosure and may not constitute prior art.

### SUMMARY

An aspect of the present disclosure provides a technology for simultaneously improving driver safety and convenience by utilizing auxiliary control functions of an eco-friendly vehicle in a situation in which a temporary stop is expected while driving the eco-friendly vehicle.

Another aspect of the present disclosure provides a technology for preventing accidents caused by carelessness that may occur during driving and improving the efficiency of vehicle operation.

The aspects of the present disclosure are not limited to the aspects mentioned above. Other aspects that are not mentioned should be clearly understood by those having ordinary skill in the art from the present disclosure.

In accordance with an aspect of the present disclosure, the above and other aspects can be accomplished by a driver assistance control method. The driver assistance control method includes determining an entry mode for driver assistance control based on location information of a vehicle or information received from a sensor based on a driver assistance control mode being activated. The driver assistance control method further includes determining a control stage for determining a procedure for controlling the vehicle based on the entry mode and vehicle situation information. The driver assistance control method further includes controlling the vehicle based on the control stage and battery status information.

The entry mode may include a plurality of modes based on types of points where the vehicle is expected to stop.

The points where the vehicle is expected to stop may include a tollgate, a drive-through store, a parking lot, and other points where a traffic arm is recognized.

The entry mode may be determined based on whether the vehicle has entered within a preset threshold distance from a point where the vehicle is expected to stop.

The entry mode is determined based on whether the vehicle is expected to arrive at a point where the vehicle is expected to stop within a preset threshold time based on a current speed of the vehicle.

The control stage may be a stage for determining a procedure for controlling the vehicle before and after the vehicle is expected to stop.

The vehicle situation information may include at least one of whether the vehicle has entered within a preset threshold distance, driver's intention to decelerate or accelerate, information on detection of an object in front of the vehicle, or a combination thereof.

The driver's intention to decelerate or accelerate may be determined based on information received by an acceleration pedal sensor (APS) or a brake pedal sensor (BPS).

Controlling the vehicle may include determining a power-train (PT) mode for determining a driving mode of the vehicle or activation or deactivation of a smart regenerative brake system (SRS) according to a gradient of a road based on the control stage and the battery status information. Controlling the vehicle may further include controlling the vehicle based on at least one of the control stage or the PT mode.

The driving mode of the vehicle may include an electric vehicle (EV) mode, a passive mode, and a series mode.

In accordance with another aspect of the present disclosure, a driver assistance control apparatus includes an entry mode determination unit configured to determine an entry mode for driver assistance control based on location information of a vehicle or information received from a sensor based on a driver assistance control mode being activated. The driver assistance control apparatus further includes a control stage determination unit configured to determine a control stage for determining a procedure for controlling the vehicle based on the entry mode and vehicle situation information. The driver assistance control apparatus further includes a vehicle control unit configured to control the vehicle based on the control stage and battery status information.

The entry mode may include a plurality of modes based on types of points where the vehicle is expected to stop.

The points where the vehicle is expected to stop may include a tollgate, a drive-through store, a parking lot, and other points where a traffic arm is recognized.

The entry mode may be determined based on whether the vehicle has entered within a preset threshold distance from a point where the vehicle is expected to stop.

The entry mode may be determined based on whether the vehicle is expected to arrive at a point where the vehicle is expected to stop within a preset threshold time based on a current speed of the vehicle.

The control stage may be a stage for determining a procedure for controlling the vehicle before and after the vehicle is expected to stop.

The vehicle situation information may include at least one of whether the vehicle has entered within a preset threshold distance, driver's intention to decelerate or accelerate, information on detection of an object in front of the vehicle, or a combination thereof.

The driver's intention to decelerate or accelerate may be determined based on information received by an acceleration pedal sensor (APS) or a brake pedal sensor (BPS).

The driver assistance control apparatus may further include a power-train (PT) mode determination unit configured to determine a PT mode for determining a driving mode of the vehicle or activation or deactivation of a smart regenerative brake system (SRS) according to a gradient of a road based on the control stage and the battery status information. The vehicle control unit controls the vehicle based on at least one of the control stage or the PT mode.

The driving mode of the vehicle may include an electric vehicle (EV) mode, a passive mode, and a series mode.

### BRIEF DESCRIPTION OF THE DRAWINGS

The above and other aspects, features, and other advantages of the present disclosure should be more clearly understood from the following detailed description taken in conjunction with the accompanying drawings, in which:

FIG. 1 schematically illustrates a configuration of a driver assistance control apparatus according to an embodiment;

FIG. 2 schematically illustrates a driver assistance control method according to an embodiment;

FIG. 3 illustrates an example of a vehicle control method according to a control stage according to an embodiment; and

FIG. 4, FIG. 5, and FIG. 6 illustrate an example of a method of determining a PT mode according to a control stage and battery status information.

### DETAILED DESCRIPTION OF THE PREFERRED EMBODIMENTS

Specific structural and functional descriptions of the embodiments of the present disclosure, disclosed in the present disclosure, are merely illustrative for the purpose of explaining the embodiments according to the present disclosure. The embodiments according to the present disclosure may be implemented in various forms and should not be construed as being limited to the embodiments described in the present disclosure.

Because the embodiments according to the present disclosure can be modified in various manners and have various forms, specific embodiments are illustrated in the drawings and described in detail in the present disclosure. However, this is not intended to limit the embodiments according to the concept of the present disclosure to a specific disclosed form and should be understood to include all changes, equivalents, and substitutes included in the spirit and technical scope of the present disclosure.

All terms including technical or scientific terms have the same meanings as generally understood by a person having ordinary skill in the art to which the present disclosure pertains unless mentioned otherwise. Generally used terms, such as terms defined in a dictionary, should be interpreted to coincide with meanings of the related art from the context. Unless differently defined in the present disclosure, such terms should not be interpreted in an ideal or excessively formal manner.

Hereinafter, embodiments disclosed in the present disclosure are described in detail with reference to the attached drawings. However, identical or similar components are assigned the same reference numeral, and redundant descriptions thereof have been omitted.

In the description of the following embodiments, the term “preset” means that the value of a parameter is predetermined when the parameter is used in a process or an algorithm. Based on embodiments, the value of a parameter may be set when a process or an algorithm starts or may be set during a period in which the process or the algorithm is performed.

The terms “module” and “unit” or “part” used to signify components are used herein to aid in understanding of the components and thus they should not be considered as having specific meanings or roles. When a controller, module, unit, part, component, device, element, or the like of the present disclosure is described as having a purpose or performing an operation, function, or the like, the controller, module, unit, part, component, device, element, or the like should be considered herein as being “configured to” meet that purpose or to perform that operation or function. Each controller, module, unit, part, component, device, element, and the like may separately embody or be included with a processor and a memory, such as a non-transitory computer readable media, as part of the apparatus.

In the following description of the embodiments disclosed in the present disclosure, a detailed description of known functions and configurations incorporated herein has been omitted when the detailed description may obscure the subject matter of the present disclosure. In addition, the accompanying drawings are provided only for ease of understanding of the embodiments disclosed in the present disclosure, do not limit the technical spirit disclosed herein, and include all changes, equivalents, and substitutes included in the spirit and scope of the present disclosure.

The terms “first” and/or “second” are used to describe various components, but such components are not limited by these terms. The terms are used to discriminate one component from another component.

When a component is “coupled” or “connected” to another component, it should be understood that a third component may be present between the two components although the component may be directly coupled or connected to the other component. When a component is “directly coupled” or “directly connected” to another component, it should be understood that no element is present between the two components.

An element described in the singular form is intended to include a plurality of elements unless the context clearly indicates otherwise.

In the present disclosure, it should be further understood that the term “comprise” or “include” specifies the presence of a stated feature, figure, step, operation, component, part or combination thereof and does not preclude the presence or addition of one or more other features, figures, steps, operations, components, or combinations thereof.

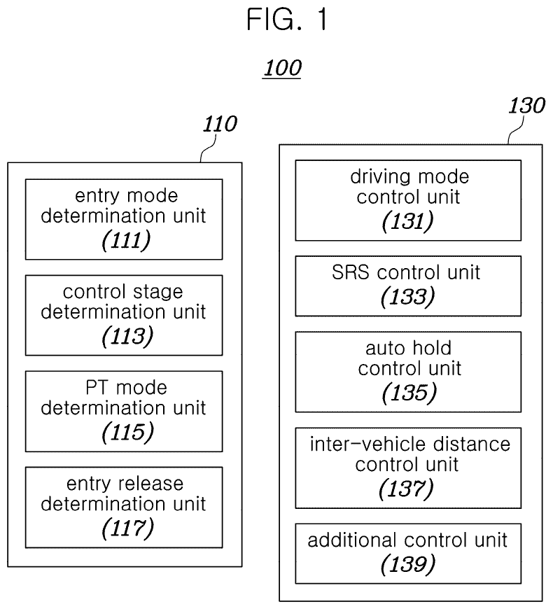

FIG. 1 schematically illustrates a configuration of a driver assistance control apparatus according to an embodiment.

Referring to FIG. 1, a driver assistance control apparatus 100 according to the present embodiment includes a determination unit 110 and a vehicle control unit 130.

The driver assistance control apparatus 100 is installed in a vehicle and can perform auxiliary functions for the safety of the vehicle in a situation in which the driver is expected to stop the vehicle.

The determination unit 110 determines an entry mode, a control stage, a power-train (PT) mode, and whether to release the entry mode for driver assistance control based on information received from a user terminal connected to the vehicle or a sensor installed in the vehicle.

The user terminal may be various terminals, such as a smartphone, a portable terminal, a mobile terminal, a foldable terminal, a personal digital assistant (PDA), a portable multimedia player (PMP) terminal, a telematics terminal, a navigation terminal, a personal computer, a notebook computer, a slate PC, a tablet, an ultrabook, a wearable apparatus (e.g., a smartwatch, smartglasses, a head mounted display (HMD), or the like), a WiBro terminal, an Internet protocol television (IPTV) terminal, a smart TV, a digital broadcasting terminal, an audio video navigation (AVN) terminal, an audio/video (A/V) system, a flexible terminal, and a digital signage apparatus.

The sensor installed in the vehicle may be a global positioning system (GPS) sensor, a front camera, a speed sensor, an accelerator pedal sensor (APS), a brake pedal sensor (BPS), an electronic toll collection sensor, or a driver's seat belt sensor.

The determination unit 110 includes an entry mode determination unit 111, a control stage determination unit 113, a PT mode determination unit 115, and an entry release determination unit 117.

The entry mode determination unit 111 determines an entry mode for driver assistance control based on location information of the vehicle or information received from a sensor installed in the vehicle when a driver assistance control function is activated.

The location information of the vehicle may be received from a user terminal connected to the vehicle, and for example, the user terminal may be a navigation terminal.

The entry mode determination unit 111 sets the entry mode to an OFF mode if the driver assistance control function is deactivated, the driver assistance control function is activated but is not in one of first to fourth modes, or a certain period of time has passed since the fifth stage determined by the control stage determination unit 113.

The entry mode may include multiple modes based on the types of points where the vehicle is expected to stop.

The points where the vehicle is expected to stop may include a tollgate, a drive-through store, a parking lot, and other points where a traffic arm is recognized.

The entry mode determination unit 111 sets the entry mode to the first mode if the vehicle enters within a preset first threshold distance from a tollgate and is expected to pass through the tollgate within a preset first threshold time based on the current vehicle speed.

At this time, the entry mode determination unit 111 may determine whether to set the entry mode to the first mode based on whether the vehicle is equipped with an electronic toll collection terminal.

For example, if the vehicle is equipped with an electronic toll collection terminal, the vehicle can pass through the tollgate without stopping, and thus the entry mode may not be set to the first mode.

On the other hand, if the vehicle is not equipped with an electronic toll collection terminal, the vehicle is expected to stop when passing through the tollgate, and thus the entry mode may be set to the first mode.

Whether the vehicle has entered within the first threshold distance from the tollgate may be determined based on information received from a navigation system.

The current vehicle speed may be received from a speed sensor installed in the vehicle.

In addition, the entry mode determination unit 111 sets the entry mode to the second mode if the vehicle enters within a second threshold distance set in advance from a destination or waypoint where drive-through is possible set in the navigation system and is expected to arrive within a second threshold time set in advance based on the current vehicle speed.

In addition, the entry mode determination unit 111 receives information indicating that an order has been placed at a drive-through store from a user terminal connected to the vehicle. The entry mode determination unit 111 sets the entry mode to the second mode if the vehicle enters within the preset second threshold distance from the store at which the order has been completed and is expected to arrive within a preset second threshold time based on the current vehicle speed.

Whether the vehicle enters within the preset second threshold distance from a destination or waypoint point, or a store at which the order has been completed, where drive-through is possible set in the navigation system may be determined based on information received from the user terminal or the navigation system.

The second threshold distance may be the same as the first threshold distance.

The second threshold time may be the same as the first threshold time.

In addition, the entry mode determination unit 111 sets the entry mode to the third mode if the vehicle enters within a preset third threshold distance from a parking lot set as a destination or a waypoint in the navigation system and is expected to arrive within a preset third threshold time based on the current vehicle speed, or the current location is a parking lot.

Whether the vehicle enters within the preset third threshold distance from a parking lot set as a destination or a waypoint in the navigation system may be determined based on information received from the navigation system.

The third threshold distance may be the same as the first or second threshold distance.

The third threshold time may be the same as the first or second threshold time.

In addition, the entry mode determination unit 111 sets the entry mode to the fourth mode when the entry mode is not one of the first to third modes, a traffic arm is recognized in front of the vehicle, and the distance to the traffic arm becomes closer within a preset fourth threshold time.

Whether a traffic arm is recognized in front of the vehicle may be determined based on information received from a front camera.

The entry mode determination unit 111 may determine the entry mode by applying the following priorities if conditions that overlap in multiple modes among the first to fourth modes are met.

First, when a destination or a waypoint is set in the navigation system, the entry mode is determined based on the closest destination or waypoint among current driving routes of the vehicle.

Second, when a destination or a waypoint is not set in the navigation system, the entry mode is determined based on the closest location among the current expected driving routes of the vehicle.

Third, the fourth mode is set to the lowest priority among the first to fourth modes.

The first to fourth modes are merely examples, and the entry mode may include various numbers of modes based on the types of points where the vehicle is expected to stop.

The control stage determination unit 113 determines a control stage for determining a procedure for controlling the vehicle before and after the vehicle is expected to stop based on the entry mode determined by the entry mode determination unit 111 and information on vehicle situation.

The procedure for controlling the vehicle until the time when the vehicle is expected to stop or when the vehicle travels after stopping may be a procedure for maintaining or changing at least one of the driving mode of the vehicle, whether the smart regenerative brake system (SRS) is activated, the stage of regenerative braking, whether the auto hold is activated, whether an additional function control is activated, or a combination thereof.

The control stage may be one of 0-th stage to the fifth stage.

The control stage determination unit 113 sets the control stage to the 0-th stage when the entry mode set by the entry mode determination unit 111 is the OFF mode or when an entry mode release condition occurs.

In addition, the control stage determination unit 113 sets the control stage to the first stage when the entry mode set by the entry mode determination unit 111 is set to the first to fourth modes from the OFF mode.

The control stage determination unit 113 sets the control stage to the second stage when the vehicle enters a destination set in the navigation system within the preset fourth threshold distance and the driver is determined to intend to decelerate in the first control stage.

The fourth threshold distance may be the same as the second threshold distance when the entry mode set by the entry mode determination unit 111 is the second mode.

The fourth threshold distance may be the same as the third threshold distance when the entry mode set by the entry mode determination unit 111 is the third mode.

The driver's intention to decelerate may be determined based on information received from an APS or a BPS.

If the vehicle speed decreases or the driver depresses the brake pedal or releases the accelerator pedal, it can be determined that the driver intends to decelerate.

In addition, the control stage determination unit 113 sets the control stage to the third stage when the entry mode set by the entry mode determination unit 111 is one of the first to third modes, the vehicle arrives at a tollgate, a drive-through store, or a parking lot and stops, a ticket machine or a person is detected on the front left side of the vehicle within a preset time from the time of stopping, and the ticket machine or the person approaches within a preset distance from the vehicle in the second or fourth control stage.

In addition, the control stage determination unit 113 sets the control stage to the third stage when the entry mode set by the entry mode determination unit 111 is the fourth mode, and the vehicle stops within a preset threshold distance from a recognized traffic arm in the first control stage.

In addition, the control stage determination unit 113 sets the control stage to the fourth stage when the driver is in the driver's seat, wears the safety belt, and intends to accelerate in the third control stage.

The driver's intention to accelerate may be determined based on information received from an APS or a BPS.

If the vehicle speed increases or the driver steps on the accelerator pedal, it can be determined that the driver intends to accelerate.

In addition, the control stage determination unit 113 sets the control stage to the fifth stage when the vehicle is located beyond the preset fourth threshold distance to a destination set in the navigation system.

The PT mode determination unit 115 determines the PT mode for determining the driving mode of the vehicle or whether to activate the smart regenerative brake system (SRS) according to the slope of a road based on the control stage determined by the control stage determination unit 113 and battery status information.

The PT mode determination unit 115 does not set the PT mode if the control stage is the 0-th stage.

If the PT mode is not set, the driving mode of the vehicle can be maintained as the previously set driving mode.

In addition, the PT mode determination unit 115 sets the PT mode to a first mode if the control stage is the first stage and the state of charge (SoC) of the battery is a first or second SoC.

In the present disclosure, the PT mode may be a mode for switching the powertrain mode according to the slope of a road in each PT mode, or for activating the EV mode and the smart regenerative braking mode, rather than a general powertrain mode.

The SoC of the battery may include the first SoC to the fifth SoC according to the charging rate of the battery.

For example, when an SoC equal to or more than 90% or more may be the first SoC, an SoC equal to or more than 70% and less than 90% may be the second SoC, an SoC equal to or more than 30% and less than 70% may be the third SoC, an SoC equal to or more than 10% and less than 30% may be the fourth SoC, and an SoC less than 10% may be the fifth SoC. This is merely an example, and the ranges of the first SoC to the fifth SoC may be set in various manners.

When the PT mode is the first mode, the driving mode of the vehicle may be set to the EV mode or a passive mode depending on the slope of the road on which the vehicle is traveling.

In the present disclosure, vehicle driving states, such as the EV mode, the passive mode, and a series mode, are defined as “driving modes” and the driving modes may be used interchangeably with the “powertrain mode”.

For example, if the gradient (e.g., slope) of the road on which the vehicle is traveling is determined as positive when the road is uphill, determined as 0 when the road is flat, and determined as negative when the road is downhill, the driving mode of the vehicle may be set to the EV mode if the gradient of the road is equal to or greater than 0 and set to the passive mode if the gradient is less than 0. This is merely an example, and the driving mode of the vehicle may be set in various ways depending on the gradient.

In this case, the EV mode is a mode in which the vehicle is driven only by the motor without an internal combustion engine. At this time, the motor is powered by the battery to operate.

In addition, in the passive mode, the engine does not provide the driving power, but the engine rotates while the engine clutch is engaged. In this situation, the engine can act as a kind of “mechanical resistance”. Here, “resistance” means that the engine does not simply supply power but can burden the power transmission system due to mechanical factors such as friction, compression, and inertia. Therefore, the engine aids in recovering the energy stored in the battery when the vehicle decelerates. This can provide an engine braking effect.

The PT mode determination unit 115 sets the PT mode to the second mode when the control stage is the first stage and the SoC of the battery is the third charging state.

Here, when the PT mode is the second mode, the EV mode and the SRS of the vehicle may be activated based on the gradient of the road on which the vehicle is traveling.

For example, when the gradient of the road on which the vehicle is traveling is equal to or greater than 0, the EV mode and SRS may be activated, and when the gradient of the road on which the vehicle is traveling is equal to or less than 0, the EV mode and SRS may not be activated.

In addition, the PT mode determination unit 115 sets the PT mode to the third mode when the control stage is the first stage and the SoC of the battery is the fourth or fifth charging state.

Here, when the PT mode is the third mode, the driving mode of the vehicle may be set to the series mode.

In the series mode, the vehicle is driven only by the motor, and the internal combustion engine can only charge the battery.

In addition, the PT mode determination unit 115 sets the PT mode to the first mode if the SoC of the battery is the first charging state, sets the PT mode to the second mode if the SoC of the battery is one of the second to fourth charging states, and does not set the PT mode when the SoC of the battery is the fifth charging state when the control stage is the second stage.

In addition, the PT mode determination unit 115 sets the PT mode to the second mode if the SoC of the battery is one of the first to fourth charging states, and the PT mode determination unit 115 does not set the PT mode if the SoC of the battery is the fifth charging state when the control stage is the third stage.

In addition, the PT mode determination unit 115 sets the PT mode to the first mode if the SoC of the battery is the first state, sets the PT mode to the second mode if the SoC of the battery is one of the second to fourth states, and does not set the PT mode if the SoC of the battery is the fifth state when the control stage is the fourth stage.

In addition, the PT mode determination unit 115 may set the driving mode of the vehicle based on the determined PT mode and the gradient of the road on which the vehicle is traveling.

For example, the PT mode determination unit 115 may set the driving mode of the vehicle to the EV mode when the PT mode is the first mode and the gradient of the road is equal to or greater than 0 and may set the driving mode to the passive mode when the gradient is less than 0.

In addition, the PT mode determination unit 115 may set the driving mode of the vehicle to the EV mode when the PT mode is the second mode and the gradient of the road is equal to or greater than 0.

The PT mode determination unit 115 may set the driving mode to the series mode when the PT mode is the third mode.

The entry release determination unit 117 determines whether to release the entry mode for driver assistance control.

The entry release determination unit 117 sets the entry mode to the OFF mode when the driver assistance control function is deactivated, the driver assistance control function is activated but is not one of the first to fourth modes, or a certain period of time has passed since the fifth stage determined by the control stage determination unit 113.

The vehicle control unit 130 controls the vehicle based on the entry mode, the control stage, the PT mode, and whether to release the entry mode for driver assistance control determined by the determination unit 110.

The vehicle control unit 130 includes a driving mode control unit 131, an SRS control unit 133, an auto hold control unit 135, an inter-vehicle distance control unit 137, and an additional control unit 139.

The driving mode control unit 131 drives the vehicle based on the driving mode of the vehicle determined by the PT mode determination unit 115.

When the driving mode of the vehicle is set to EV mode by the PT mode determination unit 115, the driving mode control unit 131 drives the vehicle in the EV mode except cases in which there is an engine start request for essential learning or diagnosis or vehicle system protection.

The SRS control unit 133 activates the smart regenerative braking system (SRS) when the PT mode is set to the second mode by the PT mode determination unit 115.

In addition, the SRS control unit 133 may increase the stage of regenerative braking when the control stage is set to the third or fourth stage by the control stage determination unit 113.

The auto hold control unit 135 does not perform control when auto hold is activated by the driver. When the auto hold is deactivated by the driver and the control stage determination unit 113 sets the control stage to the third stage, the auto hold control unit 135 turns on the auto hold function to stop the vehicle without the driver depressing the brake pedal or changing gears.

The inter-vehicle distance control unit 137 maintains the distance from a preceding vehicle to a preset distance or more when the control stage is set to the second to fourth stages by the control stage determination unit 113.

The additional control unit 139 turns on a media mute function and turns off the headlights and wipers when the control stage is set to the third stage by the control stage determination unit 113 and the driver's window is open.

In addition, when the control stage is set to the fourth stage by the control stage determination unit 113, the additional control unit 139 closes the driver's seat window and restores the media, headlights, and wipers to original states thereof.

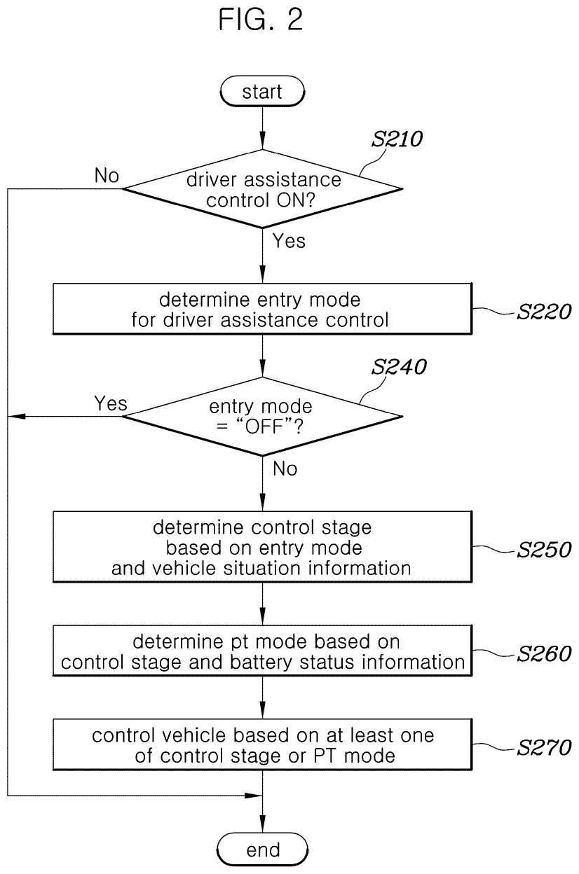

FIG. 2 schematically illustrates a driver assistance control method according to an embodiment.

The driver assistance control method according to the present embodiment may be performed by the driver assistance control apparatus 100 of FIG. 1.

Referring to FIG. 2, the driver assistance control apparatus 100 determines whether the driver assistance control mode is in an ON state, i.e., whether the driver assistance control mode is activated (S210). If the driver assistance control mode is in the ON state (Yes in S210), i.e., the driver assistance control mode is activated, the driver assistance control apparatus 100 determines an entry mode for driver assistance control (S220).

At this time, the entry mode for driver assistance control may be determined by an entry mode determination algorithm of the entry mode determination unit 111 of FIG. 1.

The driver assistance control apparatus 100 determines whether the entry mode is the OFF mode (S240), and if the entry mode is the OFF mode (Yes in S240), the driver assistance control apparatus 100 terminates driver assistance control.

If the entry mode is not the OFF mode as a result of the determination in step S240 (No in S240), the driver assistance control apparatus 100 determines a control stage based on the entry mode and vehicle situation information (S250).

The control stage may be determined by a control stage determination algorithm of the control stage determination unit 113 of FIG. 1.

The driver assistance control apparatus 100 determines the PT mode based on the control stage and battery status information (S260).

The PT mode may be determined by a PT mode determination algorithm of the PT mode determination unit 115 of FIG. 1.

In addition, the driver assistance control apparatus 100 controls the vehicle based on at least one of the control stage or the PT mode (S270).

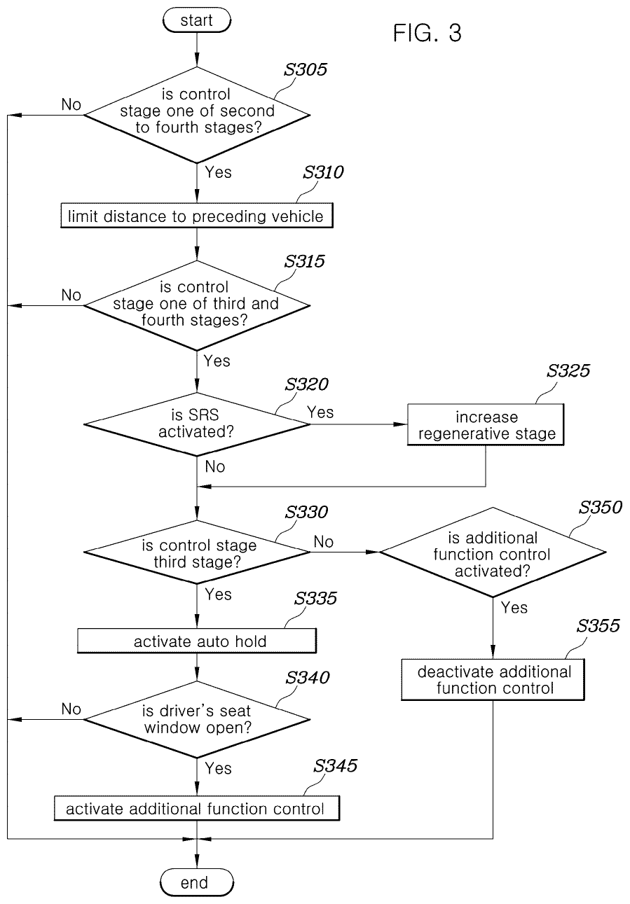

FIG. 3 shows an example of a vehicle control method depending on a control stage according to an embodiment.

The vehicle control method according to the present embodiment may be performed by the driver assistance control apparatus 100 of FIG. 1.

The vehicle control method according to the present embodiment may correspond to step S270 of FIG. 2.

Referring to FIG. 3, the driver assistance control apparatus 100 determines whether the control stage is one of the second to fourth stages (S305). If the control stage is one of the second to fourth stages (Yes in S305), the driver assistance control apparatus 100 limits the distance between the subject vehicle and a preceding vehicle (S310).

At this time, the driver assistance control apparatus 100 can maintain the distance between the subject vehicle and the preceding vehicle to a preset distance or more.

In addition, the driver assistance control apparatus 100 determines whether the control stage is one of the third and fourth stages (S315). The driver assistance control apparatus 100 determines whether the SRS is activated (S320) if the control stage is one of third and fourth stages (Yes in S315). The driver assistance control apparatus 100 increases the regenerative stage (S325) if the SRS is activated (Yes in S320).

In addition, the driver assistance control apparatus 100 determines whether the control stage is the third stage (S330). The driver assistance control apparatus 100 activates auto hold (S335) if the control stage is the third stage (Yes in S330). The driver assistance control apparatus 100 determines whether the driver's seat window is open (S340). The driver assistance control apparatus 100 activates additional function control (S345) if the driver's seat window is open (Yes S340).

If the additional function control is activated, the driver assistance control apparatus 100 may turn on the media mute function and turn off the headlights and wipers.

If the control stage is not the third stage in step S330 (No in S330), the driver assistance control apparatus 100 determines whether the additional function control is activated (S350). If the additional function control is activated (Yes in S350), the driver assistance control apparatus 100 deactivates the additional function control (S355).

If the additional function control is deactivated, the driver assistance control apparatus 100 may close the driver's seat window and restore the media, headlights, and wipers to the original states thereof.

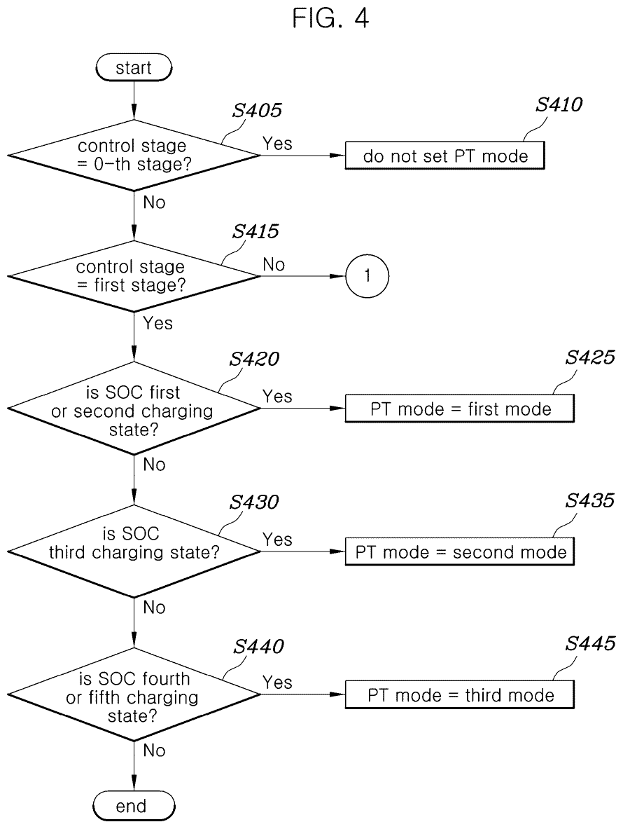

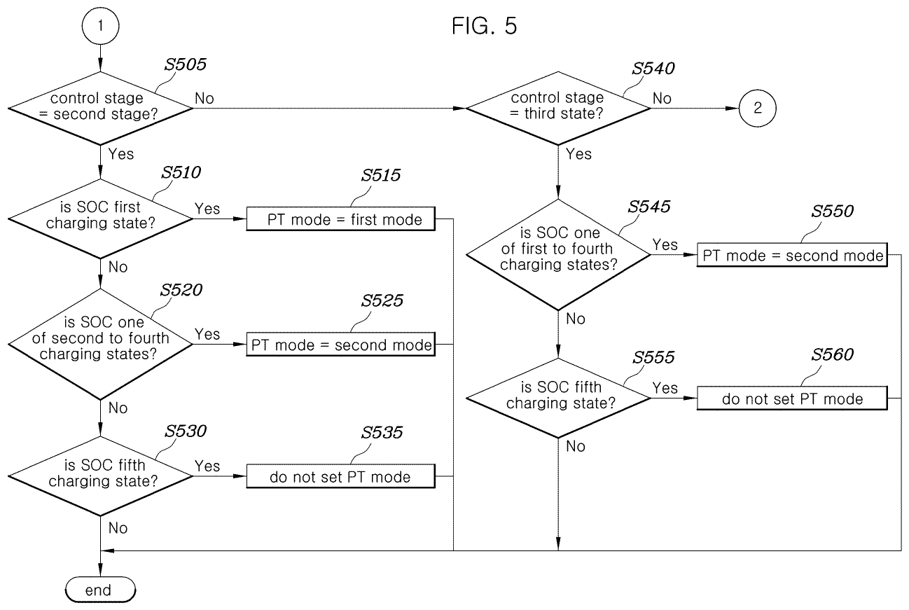

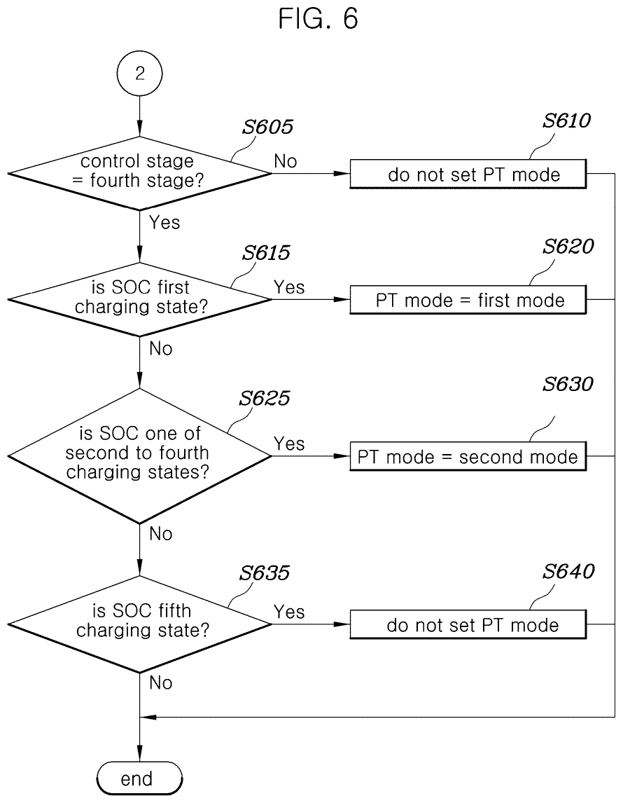

FIG. 4, FIG. 5, and FIG. 6 illustrate an example of a method of determining the PT mode depending on a control stage and battery status information.

The method of determining the PT mode according to the present embodiment may be performed by the PT mode determination unit 115 of FIG. 1.

Referring to FIG. 4, FIG. 5, and FIG. 6, the PT mode determination unit 115 determines whether the control stage is the 0-th stage (S405). If the control stage is the 0-th stage (Yes in S405), the PT mode determination unit 115 does not set the PT mode (S410).

At this time, the control stage may be set according to each condition in the control stage determination unit 113.

If the PT mode is not set, the driving mode of the vehicle may be maintained as the previously set driving mode.

In addition, the PT mode determination unit 115 determines whether the control stage is the first stage (S415) if the control stage is not the 0-th stage (S410). If the control stage is the first stage (Yes in S415), the PT mode determination unit 115 determines whether the SoC of the battery is the first or second charging state (S420).

As a result of the determination in step S420, if the SoC of the battery is the first or second charging state (Yes in S420), the PT mode determination unit 115 sets the PT mode to the first mode (S425).

As a result of the determination in step S420, if the SoC of the battery is not the first or second charging state (No in S420), the PT mode determination unit 115 determines whether the SoC of the battery is the third charging state (S430). If the SoC of the battery is the third charging state (Yes in S430), the PT mode determination unit 115 sets the PT mode to the second mode (S435).

As a result of the determination in step S430, if the SoC of the battery is not the third charging state (No in S430), the PT mode determination unit 115 determines whether the SoC of the battery is the fourth or fifth charging state (S440). If the SoC of the battery is the fourth or fifth charging state (Yes in S440), the PT mode determination unit 115 sets the PT mode to the third mode S445.

On the other hand, as a result of the determination in step S415, if the control stage is not the first stage (No in S415), the PT mode determination unit 115 determines whether the control stage is the second stage (S505). If the control stage is the second stage (Yes in S505), the PT mode determination unit 115 determines whether the SoC of the battery is the first charging state (S510).

As a result of the determination in step S510, if the SoC of the battery is the first charging state (Yes in S510), the PT mode determination unit 115 sets the PT mode to the first mode (S515).

As a result of the determination in step S510, if the SoC of the battery is not the first charging state (No in S510), the PT mode determination unit 115 determines whether the SoC of the battery is one of the second to fourth charging states (S520). If the SoC of the battery is one of the second to fourth charging states (Yes in S520), the PT mode determination unit 115 sets the PT mode to the second mode (S525).

As a result of the determination in step S520, if the SoC of the battery is not any one of the second to fourth charging states (No in S520), the PT mode determination unit 115 determines whether the SoC is the fifth charging state (S530). If the SoC of the battery is the fifth charging state (Yes in S530), the PT mode determination unit 115 does not set the PT mode (S535).

As a result of the determination in step S505, if the control stage is not the second stage (No in S505), the PT mode determination unit 115 determines whether the control stage is the third stage (S540). If the control stage is the third stage (Yes in S540), the PT mode determination unit 115 determines whether the SoC of the battery is one of the first to fourth charging states (S545).

As a result of the determination in step S545, if the SoC of the battery is one of the first to fourth charging states (Yes in S545), the PT mode determination unit 115 sets the PT mode to the second mode (S550).

As a result of the determination in step S545, if the SoC of the battery is not one of the first to fourth charging states (No in S545), the PT mode determination unit 115 determines whether the SoC of the battery is the fifth charging state (S555). If the SoC of the battery is the fifth charging state (Yes in S555), does not set the PT mode (S560).

On the other hand, if the control stage is not the third stage in step S540 (No in S540), the PT mode determination unit 115 determines whether the control stage is the fourth stage (S605). If the control stage is not the fourth stage (No in S605), the PT mode determination unit 115 does not set the PT mode (S610).

In addition, if the control stage is the fourth stage in step S605 (Yes in S605), the PT mode determination unit 115 determines whether the SoC of the battery is the first charging state (S615). If the SoC of the battery is the first charging state (Yes in S615), sets the PT mode to the first mode (S620).

If the SoC of the battery is not the first charging state in step S615 (No in S615), the PT mode determination unit 115 determines whether the SoC of the battery is one of the second to fourth charging states (S625). If the SoC of the battery is one of the second to fourth charging states (Yes in S625), the PT mode determination unit 115 sets the PT mode to the second mode (S630).

If the SoC of the battery is not any one of the second to fourth charging states in S625 (No in S625), the PT mode determination unit 115 determines whether the SoC of the battery is the fifth charging state (S635). If the SoC of the battery is the fifth charging state (Yes in S635), the PT mode determination unit 115 does not set the PT mode (S640).

The PT mode set as above can be used to set the driving mode of the vehicle depending on the gradient of the road.

For example, when the PT mode is the first mode and the gradient of the road is 0 or higher, the driving mode of the vehicle may be set to the EV mode. When the gradient is less than 0, the driving mode may be set to the passive mode.

In addition, when the PT mode is the second mode and the gradient is equal to or greater than 0, the driving mode of the vehicle may be set to the EV mode.

In addition, when the PT mode is the third mode, the driving mode may be set to the series mode.

According to the embodiments described above, a technology capable of simultaneously improving driver safety and convenience by utilizing the auxiliary control function of the vehicle in a situation in which a temporary stop is expected while driving an eco-friendly vehicle is provided.

In addition, a technology capable of preventing accidents caused by carelessness that may occur during driving and improving the efficiency of vehicle operation is provided.

Furthermore, working environments of workers working near vehicles can be improved by minimizing engine operation.

The effects that can be obtained in the disclosed embodiments are not limited to the effects mentioned above. Other effects that are not mentioned can be clearly understood by a person having ordinary skill in the art to which the embodiments belong from the present disclosure.

The above-described embodiments can be implemented as computer-readable code on a medium in which a program is recorded. A computer-readable medium includes any type of recording apparatus that stores data that can be read by a computer system. Examples of computer-readable media include a hard disk drive (HDD), a solid state drive (SSD), a silicon disk drive (SDD), a ROM, a RAM, a CD-ROM, a magnetic tape, a floppy disk, an optical data storage apparatus, etc. Accordingly, the above detailed description should not be construed as limiting in all aspects but as illustrative. The scope of the present disclosure should be determined by a reasonable interpretation of the appended claims, and all changes within the equivalent scope of the present disclosure are intended to be included in the scope of the present disclosure.

Although the embodiments of the present disclosure have been disclosed for illustrative purposes, those having ordinary skill in the art should appreciate that various modifications, additions, and substitutions are possible, without departing from the scope and spirit of the present disclosure as disclosed in the accompanying claims.

What is claimed is:

1. A driver assistance control method, the method comprising:
determining an entry mode for driver assistance control based on location information of a vehicle or information received from a sensor based on a driver assistance control mode being activated;
determining a control stage for determining a procedure for controlling the vehicle based on the entry mode and vehicle situation information; and
controlling the vehicle based on the control stage and battery status information.

2. The method of claim 1, wherein the entry mode includes a plurality of modes based on types of points where the vehicle is expected to stop.

3. The method of claim 2, wherein the points where the vehicle is expected to stop include a tollgate, a drive-through store, a parking lot, and other points where a traffic arm is recognized.

4. The method of claim 2, wherein the entry mode is determined based on whether the vehicle has entered within a preset threshold distance from a point where the vehicle is expected to stop.

5. The method of claim 1, wherein the entry mode is determined based on whether the vehicle is expected to arrive at a point where the vehicle is expected to stop within a preset threshold time based on a current speed of the vehicle.

6. The method of claim 1, wherein the control stage is a stage for determining a procedure for controlling the vehicle before and after the vehicle is expected to stop.

7. The method of claim 1, wherein the vehicle situation information includes at least one of whether the vehicle has entered within a preset threshold distance, an intention of a driver to decelerate or accelerate, information on detection of an object in front of the vehicle, or a combination thereof.

8. The method of claim 7, wherein the intention of the driver to decelerate or accelerate is determined based on information received by an acceleration pedal sensor (APS) or a brake pedal sensor (BPS).

9. The method of claim 1, wherein controlling the vehicle comprises:
determining a power-train (PT) mode for determining a driving mode of the vehicle or activation or deactivation of a smart regenerative brake system (SRS) according to a gradient of a road based on the control stage and the battery status information; and
controlling the vehicle based on at least one of the control stage or the PT mode.

10. The method of claim 9, wherein the driving mode of the vehicle includes an electric vehicle (EV) mode, a passive mode, and a series mode.

11. A driver assistance control apparatus, the apparatus comprising:
an entry mode determination unit configured to determine an entry mode for driver assistance control based on location information of a vehicle or information received from a sensor based on a driver assistance control mode being activated;
a control stage determination unit configured to determine a control stage for determining a procedure for controlling the vehicle based on the entry mode and vehicle situation information; and
a vehicle control unit configured to control the vehicle based on the control stage and battery status information.

12. The apparatus of claim 11, wherein the entry mode includes a plurality of modes based on types of points where the vehicle is expected to stop.

13. The apparatus of claim 12, wherein the points where the vehicle is expected to stop include a tollgate, a drive-through store, a parking lot, and other points where a traffic arm is recognized.

14. The apparatus of claim 12, wherein the entry mode is determined based on whether the vehicle has entered within a preset threshold distance from a point where the vehicle is expected to stop.

15. The apparatus of claim 11, wherein the entry mode is determined based on whether the vehicle is expected to arrive at a point where the vehicle is expected to stop within a preset threshold time based on a current speed of the vehicle.

16. The apparatus of claim 11, wherein the control stage is a stage for determining a procedure for controlling the vehicle before and after the vehicle is expected to stop.

17. The apparatus of claim 11, wherein the vehicle situation information includes at least one of whether the vehicle has entered within a preset threshold distance, an intention of a driver to decelerate or accelerate, information on detection of an object in front of the vehicle, or a combination thereof.

18. The apparatus of claim 17, wherein the intention of the driver to decelerate or accelerate is determined based on information received by an acceleration pedal sensor (APS) or a brake pedal sensor (BPS).

19. The apparatus of claim 11, further comprising a power-train (PT) mode determination unit configured to determine a PT mode for determining a driving mode of the vehicle or activation or deactivation of a smart regenerative brake system (SRS) according to a gradient of a road based on the control stage and the battery status information,
wherein the vehicle control unit controls the vehicle based on at least one of the control stage or the PT mode.

20. The apparatus of claim 19, wherein the driving mode of the vehicle includes an electric vehicle (EV) mode, a passive mode, and a series mode.
